(19) United States
(12) Patent Application Publication
(10) Pub. No.: US 2005/0158621 A1
(43) Pub. Date: Jul. 21, 2005

(54) Battery with flat housing

(76) Inventors: Stephen A. Benoit, Southbury, CT (US); Fred J. Berkowitz, New Milford, CT (US); Mark Brown, Brookfield, CT (US); Jordan Bourilkov, Stamford, CT (US); John Rotondo, Trumbull, CT (US); David Klein, Southbury, CT (US); Bryan L. Hesse, Guilford, CT (US); Jaroslav Janik, Southbury, CT (US)

Correspondence Address: Barry D. Josephs;Attorney At Law, 19 North St., Sales, MA, 01970, US

(21) Appl. No.: 11/028,245

(22) Filed: Jan. 3, 2005

Related U.S. Application Data
(63) Continuation-in-part of application No. 10/675,512, filed on Sep. 30, 2003.

(51) Int. Cl. H01M 2/30; H01M 4/50; H01M 6/10; H01M 6/00; H01M 2/02

(52) U.S. Cl. 429/178; 429/224; 429/94; 429/162; 429/180

(57) ABSTRACT

A primary battery having at least one flat side running along its length. The battery can be used, for example, in a digital camera. The battery can have an anode comprising lithium and low resistance contacts. The anode and cathode can be in the form of sheets which are spirally wound with separator therebetween. The negative and positive contacts are uniquely positioned to prevent recharging the battery in the event that the battery is inserted into a conventional recharger designed for same size rechargeable batteries.

### CROSS REFERENCE TO RELATED APPLICATIONS

This application is a continuation in part of application Ser. No. 10/675,512 filed Sep. 30, 2003.

### TECHNICAL FIELD

This invention relates to a primary lithium battery, particularly a primary lithium battery having a flat housing.

### BACKGROUND

Digital cameras and other electronic devices (for example, cell phones, MP3 players, and personal digital assistants (PDA's) such as BlackBerries®) operate on batteries, such as secondary (i.e., rechargeable) nickel metal hydride batteries or secondary lithium ion batteries. One type of battery that has been used in digital cameras is the Pentax D-L12, a 3.7 V secondary, prismatic lithium ion battery available from Panasonic and depicted in FIGS. 1 and 2.

Referring to FIG. 1, battery 10 has a length “L” of about 53.0 mm, a width “W” of about 35.2 mm, and a thickness “T” of about 7.0 mm. In this application, the type of prismatic cell illustrated in FIGS. 1 and 2 generally will be referred to as “Battery A”. Other specific examples of Battery A-type batteries include the Pentax D-L12B, the Gold Peak VFL001, the Panasonic VW-VBA10, the Mugen Power HLI-NP60, and the Fujifilm NP60.

Referring now to FIG. 2, a surface 12 of battery 10 has three electrical contacts 14, 16, and 18 positioned in a side-by-side arrangement. Contact 14 is positive, and contact 18 is negative. Contact 16, located between, and at an equal distance from, contacts 14 and 18, is a thermistor. The thermistor is a thermally sensitive resistor that regulates recharging. As battery 10 is charged, the temperature of the battery increases, thereby causing the thermistor to increase its resistance to current flow. As a result, the charge current through battery 10 decreases. If battery 10 becomes too hot, then the thermistor shuts off the charge. When battery 10 is inserted into a digital camera or charger, contacts 14, 16, and 18 touch corresponding contacts in the camera or charger.

Another example of a secondary, prismatic lithium ion battery is the Casio NP20. The type of battery exemplified by the Casio NP20 will generally be referred to as “Battery B”. Battery B has three electrical contacts (a positive contact, a thermistor, and a negative contact), and its dimensions are 50 mm×33 mm×4.5 mm.

Another example of a secondary, prismatic lithium ion battery is the Olympus LI-10B. The type of battery exemplified by the Olympus LI-10B will generally be referred to as “Battery C”. Battery C has three electrical contacts (a positive contact, a thermistor, and a negative contact), and its dimensions are 46 mm×32 mm×9.7 mm.

Another example of a secondary, prismatic lithium ion battery is the Motorola SNN5717C. The type of battery exemplified by the Motorola SNN5717C will generally be referred to as “Battery D”.

Battery D has four electrical contacts (a positive contact, a thermistor, a resistor, and a negative contact), and its dimensions are 58 mm×35.6 mm×7.0 mm. A resistor can help an electronic device (e.g., a digital camera, a charger) to identify the chemistry of a battery.

Another example of a secondary, prismatic lithium ion battery is the Motorola SNN5705B. The type of battery exemplified by the Motorola SNN5705B will generally be referred to as “Battery E”. Battery E has four electrical contacts (a positive contact, a thermistor, a resistor, and a negative contact), and its dimensions are 58 mm×35.6 mm×4.6 mm.

Another example of a secondary, prismatic lithium ion battery is the Nokia BL-5C. The type of battery exemplified by the Nokia BL-5C will generally be referred to as “Battery F”. Battery F has four electrical contacts (a positive contact, a thermistor, a resistor, and a negative contact), and its dimensions are 53 mm×34 mm×5.7 mm.

Another example of a secondary, prismatic lithium ion battery is the BlackBerry® BAT-03087-002. The type of battery exemplified by the BlackBerry® BAT-03087-002 will generally be referred to as “Battery G”. Battery G has four electrical contacts (a positive contact, a thermistor, a resistor, and a negative contact), and its dimensions are 50.5 mm×38 mm×7.1 mm.

### SUMMARY

The invention generally relates to a primary battery (e.g., a lithium battery) for use in an electronic device (e.g., a digital camera, a cell phone, an MP3 player, or a personal digital assistant (PDA) such as a BlackBerry®).

In one aspect, the primary battery has approximately the same dimensions as Battery A, but has at least one positive or negative contact that is positioned in a location different from the location of the corresponding positive or negative contact in Battery A.

In some embodiments, the primary battery includes recess(es) that correspond to the positions of the positive contact and/or negative contact in Battery A. The positive and/or negative contacts for which there are recesses in the primary battery have been repositioned in the primary battery relative to Battery A. The primary battery preferably does not include a thermistor that has an independent contact (i.e., separate from the positive and negative contacts) on the battery housing. In certain embodiments, the primary battery may include a recess corresponding to the position of the thermistor in Battery A. A primary battery that includes the recess(es) can be used in digital cameras with contacts that allow the camera to operate with either Battery A or primary batteries. However, if the primary battery is accidentally placed in a charger intended for use with Battery A, it will not recharge because it does not have a set of contacts that correspond to the contacts in the charger. This is advantageous to a user of the primary battery because the user does not have to be concerned about, for example, overheating of the primary battery when it is accidentally placed in the charger. The primary battery can be designed to fit, for example, into a small and/or thin-profile digital camera. Another advantage is that the primary battery does not require the user to carry and/or travel with burdensome accessories such as AC power cords and chargers.

In an aspect of the invention the positive and negative contact terminals are formed of a metal substrate which is overplated with gold on the exposed side of the metal substrate. Preferably the metal substrate is of nickel or comprised substantially of nickel. It is advantageous to have either the negative or positive contact formed a nickel substrate which is overplated on its exposed surface with at least one layer of gold. Preferably both negative and positive contacts are formed of a nickel substrate which are overplated on their exposed surface with a layer of gold. Lithium primary cells are conventionally comprised of unplated terminals comprising nickel. The lithium primary battery of the invention has a housing with at least one substantially flat side running along the length of the battery. Desirably the lithium primary battery of the invention has a pair of opposing flat sides running along the length of the battery. The two opposing flat sides may typically be parallel. The battery of the invention thus can have a flat or prismatic shape and is intended in a preferred application to be a replacement for lithium ion rechargeable batteries typically used to service digital cameras.

It has been determined that the gold overplate on the exposed surface of the negative and positive contact terminals of the battery of the invention significantly improves the performance of the battery, particularly when the battery is used in high power electronic devices, for example, digital cameras. Such digital cameras have an average pulsed or intermittent power demand between about 2 and 6 Watt, typically between about 2 and 3 watt, with peak power demand between about 4 and 6 watt. It has been determined that with conventional nickel terminal contacts the contact resistance between the terminals of the primary lithium battery of the invention and the digital camera terminals can be elevated. The contact resistance can in some circumstances be high enough to interfere with consistently achieving the desired pulsed or intermittent power output in the above range, regardless of whether the camera contacts terminals are gold plated and regardless of the contact force applied between the battery terminals and the camera terminals.

In a specific aspect it has been determined that both negative and positive terminals of the primary lithium battery of the invention, can be gold plated on the exposed surface to sufficiently reduce the contact resistance between the battery terminals and the camera terminals. Although a principal application of the battery of the invention is made with reference to powering high power digital cameras, it will be appreciated that the invention is not intended to be limited to application to cameras. Rather the battery can be used to power other high power devices, for example MP3 audio players and the like, and in general can be used as a replacement for prismatic rechargeable lithium ion batteries.

Improvement in battery performance may be obtained if only one of the battery contact terminals is overplated with gold. However, it is preferred to over plate both negative and positive contact terminals of the battery of the invention with at least one layer of gold on the exposed surface of the terminal. Desirably both negative and positive terminals of the primary lithium battery of the invention is formed of a metal substrate of nickel or comprising substantially of nickel or alloy containing nickel and such metal substrate is overplated on its exposed surface with a layer of gold. The plating may be accomplished using conventional electroplating methods and is effected so that the average thickness of the gold plate is between about 0.1 and 5 micron, preferably between about 0.25 and 5.0 micron. A significant improvement in contact resistance between such gold plated battery terminals and the digital camera terminals is realized compared to unplated nickel battery terminals even if the contact force between the battery terminals and the camera terminals is perturbed over a broad range between about 30 and 400 grams force. There is noted a marked decrease in the electrical contact resistance between gold plated nickel battery terminals and the digital camera terminals to an average level of at least between about 20 and 90 percent less, typically at least 50 percent less than if the same battery terminals were not plated with gold. Such decrease in electrical contact resistance has been determined to apply over a broad range in contact force between about 50 and 400 grams force even when the device terminals are also plated with gold. It is desirable to produce a relatively hard gold plating on the surface for battery contact terminals. If the gold plate is too soft unwanted indentations in the terminal surface may occur during handling and usage. Thus the gold plate is desirably applied so that the gold plate thickness is preferably between about 0.25 and 5 micron and the gold plate has a Knoop micro hardness of between about 130 and 200 HK₂₅ (Knoop hardness as measured under a 25 gram load).

In another aspect, the primary battery (e.g., a lithium battery) has approximately the same dimensions as Battery B, C, D, E, F, or G. The primary battery can be different from Battery B, C, D, E, F, or G in one or more of the ways discussed above with respect to the first aspect of the invention. For example, the primary battery can have at least one positive or negative contact that is positioned in a location different from the location of the corresponding positive or negative contact in Battery B, C, D, E, F, or G.

In another aspect, the primary battery includes a housing having a thickness between about 2 mm and about 15 mm, a width between about 10 mm and about 50 mm, and a length between about 20 mm and about 60 mm. The primary battery also includes a positive electrical contact and a negative electrical contact located on a surface of the housing. Within the housing are an anode, a cathode, and an electrolyte. The battery does not include a thermistor that has an independent contact on the battery housing.

In another aspect, the primary battery includes a housing having a thickness between about 2 mm and about 15 mm, a width between about 10 mm and about 50 mm, and a length between about 20 mm and about 60 mm. Within the housing are an anode, a cathode, and an electrolyte. The primary battery also includes a positive electrical contact and a negative electrical contact located on a surface of the housing. The positive electrical contact and the negative electrical contact each occupy a contact space of about the same size, and are separated by a space that is at least big enough to provide adequate insulation between the contacts (e.g., to prevent an electrical short between the contacts). In some embodiments, the positive electrical contact and the negative electrical contact are separated by a space that is approximately equal in size to the contact space. In certain embodiments, the positive electrical contact and the negative electrical contact are separated by a space that is at least about 1.5 times the size of the contact space (e.g., at least about two times the size of the contact space, at least about 2.5 times the size of the contact space).

In some embodiments, the above batteries do not include a thermistor that has an independent contact on the battery housing.

In another aspect, the primary battery includes a prismatic housing having a thickness between about 2 mm and about 15 mm, a width between about 10 mm and about 50 mm, and a length between about 20 mm and about 60 mm. Within the housing are an anode, a cathode, and an electrolyte. The primary battery also includes a positive electrical contact and a negative electrical contact located on a surface on the housing, at opposite ends of the surface.

In another aspect, the primary battery includes a housing (e.g., having a thickness between about 2 mm and about 15 mm, a width between about 10 mm and about 50 mm, and a length between about 20 mm and about 60 mm). Within the housing are an anode, a cathode, and an electrolyte. A positive electrical contact and a negative electrical contact are on a surface of the housing. The negative contact also functions as a resistor.

In another aspect, the primary battery is a 3 Volt battery that includes a prismatic housing having a thickness between about 2 mm and about 15 mm, a width between about 10 mm and about 50 mm, and a length between about 20 mm and about 60 mm. Within the housing are an anode, a cathode, and an electrolyte. A positive electrical contact and a negative electrical contact on a surface on the housing.

In another aspect, the invention features a digital camera that can be used with one or more of the above batteries. In some embodiments, the camera has a housing with a surface that includes three electrical contacts: a positive electrical contact, a negative electrical contact, and a positive or negative electrical contact.

As used herein, the term “primary battery” refers to a battery that is designed to be discharged, e.g., to exhaustion, only once, and then discarded. Primary batteries are described, for example, in David Linden, Handbook of Batteries (McGraw-Hill, 2d ed. 1995).

For the purposes of this application, a “prismatic cell” has at least four generally flat sides, and has one dimension (e.g., thickness) that is substantially smaller than two other dimensions (e.g., length and width). As an example, a prismatic cell can have a thickness of between about 2 mm and about 15 mm (e.g., between about 4 mm and about 10 mm), a width of between about 10 mm and about 50 mm (e.g., between about 20 mm and about 40 mm), and a length of between about 20 mm and about 60 mm (e.g., between about 30 mm and about 40 mm).

Other features and advantages are in the description, drawings, and claims.

### DESCRIPTION OF DRAWINGS

FIG. 1 is a perspective view of a battery.

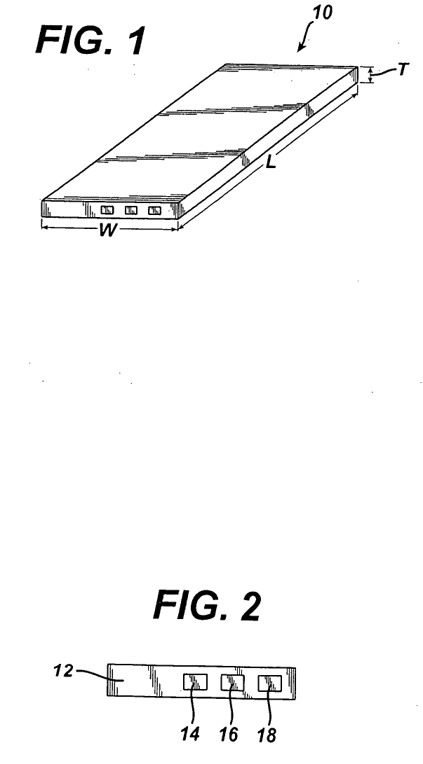

FIG. 2 is a top view of the battery of FIG. 1.

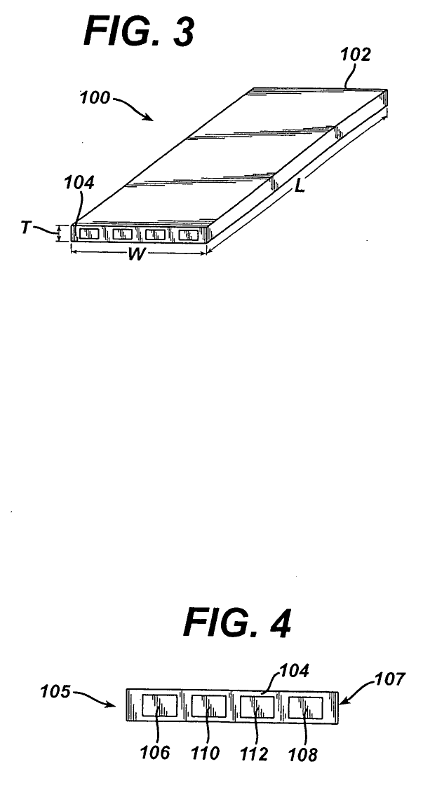

FIG. 3 is a perspective view of a battery.

FIG. 4 is a top view of the battery of FIG. 3.

FIG. 5 is a cross-sectional view of the cell of the battery of FIG. 3.

FIG. 6 is a perspective view of the battery of FIG. 3.

FIG. 7A is a perspective view of a component of the battery of FIG. 3.

FIGS. 7B, 7C, 7D, 7E, 7F, 7G, 7H, 7I, and 7J illustrate a method of making the battery of FIG. 3.

FIG. 8 is a top view of a battery.

### DETAILED DESCRIPTION

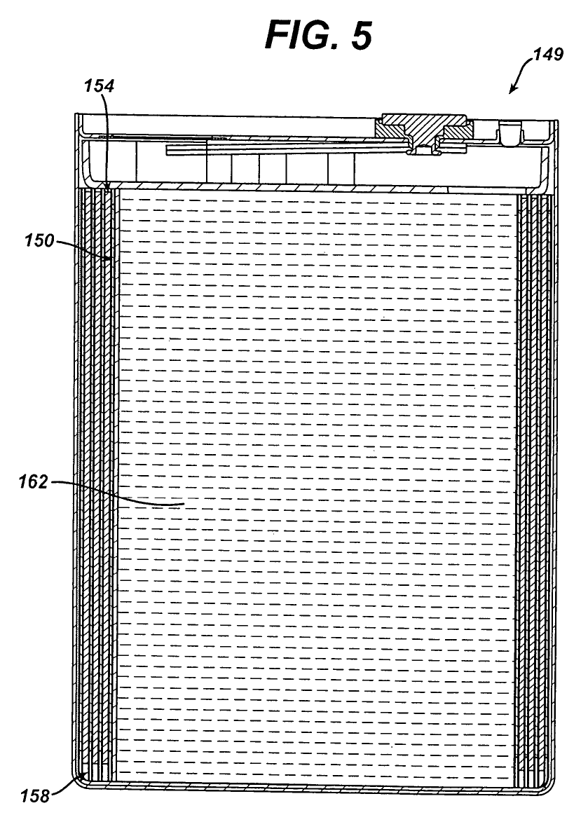

Referring to FIG. 3, a primary lithium battery 100 includes a housing 102 having a surface 104. Surface 104 includes two ends, 105 and 107, that define the width of battery 100. Battery 100 has the same general shape and dimensions as Battery A. Thus, battery 100 can fit into a space in a digital camera that is also capable of fitting Battery A. However, battery 100 is a 3 V battery, and thus has a different voltage from Battery A. Housing 102 can be made of a metal or metal alloy (e.g., nickel, nickel plated steel, stainless steel, aluminum, an alloy containing aluminum) or a plastic (e.g., a polyamide, polyvinyl chloride, polypropylene, polysulfone, acrylonitrile butadiene styrene (ABS), polystyrene).

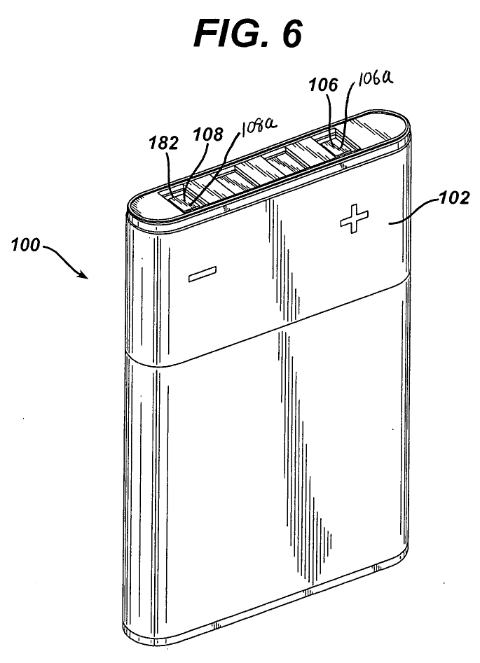

Referring now to FIG. 4, surface 104 of battery 100 includes two electrical contacts: a positive contact 106 and a negative contact 108. Between electrical contacts 106 and 108 are two recesses, 110 and 112. Positive contact 106 is located approximately at end 105 of surface 104, while negative contact 108 is located approximately at end 107 of surface 104. Generally, recesses 110 and 112 are made of non-conducting materials. Recesses 110 and 112 can be made of, for example, a plastic (e.g., a polyamide, polyvinyl chloride, polypropylene, polysulfone, acrylonitrile butadiene styrene (ABS), polystyrene). In some cases, recesses 110 and 112 are made of the same material as housing 102, while in other cases recesses 110 and 112 and housing 102 are made of different materials. If primary battery 100 were accidentally placed into a charger with contacts suitable for recharging Battery A, battery 100 would not be recharged because at least one of its electrical contacts would not touch a corresponding contact in the charger.

The negative contact 108 and positive contact 106 may be of nickel, which is the metal conventionally employed for negative and positive contacts in primary lithium cells. The term “nickel” as used herein is intended to extend to alloys of nickel or metals wherein nickel comprises at least a substantial proportion thereof. However, when the cell of the invention is used to power certain high pulsed power demanding electronic devices such as digital cameras there can be a deficiency in achieving the required battery power output when using nickel contacts. Such digital cameras may typically have a pulsed or intermittent power demand of between 2 to 6 watt with an average demand typically between about 2 to 3 watt and a peak demand between about 4 and 6 watt. It has been determined that if the exposed contact surface of terminals 108 and 106 is of nickel, the electrical resistance between such terminal contacts and corresponding terminals of some digital cameras can be sufficiently high as to interfere with proper performance of the camera. For example, the elevated contact resistance may interfere with obtaining the required pulsed power necessary to operate the cameras in the most effective manner. Upon research into the possible cause of the problem, it is believed that the formation of oxides on the surface of the nickel is at least one primary cause of the elevated contact resistance. There may be other surface phenomenon involved which are presently not well understood, particularly in connection with the effect on contact resistance as pulsed power demand is increased.

It has been determined that the contact resistance can still be sufficiently elevated to significantly interfere with obtaining the desired level of pulsed power output from the battery of the invention when using nickel terminal contacts even though the contact force between the terminals 108 and 106 and corresponding device, e.g. digital camera terminals, is substantially increased. The contact force between contacts 108 and 106 with the corresponding device terminals can be increased, for example, by increasing the spring loading on the device terminals. To some extent the increase in spring loading of the device terminal, for example, to a level of between about 150 and 400 grams force, helps to alleviate the problem. However, it has been determined that the use of nickel contacts 108 and 106 even under such high spring loadings, can result in high enough contact resistance to interfere with achieving most effective operation of some digital cameras. Additionally, many digital cameras have a lower level of spring loading of their terminal contacts, for example, between about 50 and 150 grams force. This is because a higher degree of spring loading would necessitate heavier springs or heavier spring loaded contacts within the camera battery cavity. Such heavier contacts would take up more volume within the battery cavity which in turn would increase the size of the camera. Therefore most digital camera manufacturers would prefer not to increase the spring loading of the terminal contacts therein to much above 150 grams force. However, with spring loaded camera contacts in the common range between about 50 and 150 grams force, the problem is exacerbated in that the contact resistance when using nickel contacts 108 and 106 may result in contact resistance typically up to about 30 milliohm and even higher between each of the contacts 108 and 106 and the digital camera contacts.

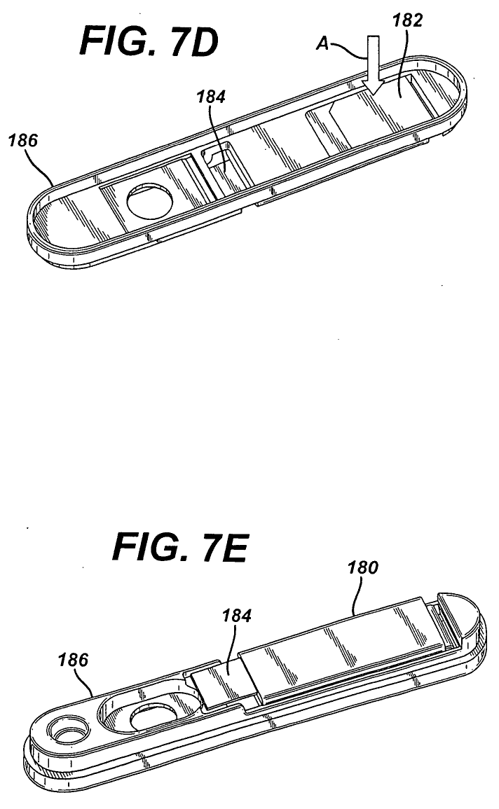

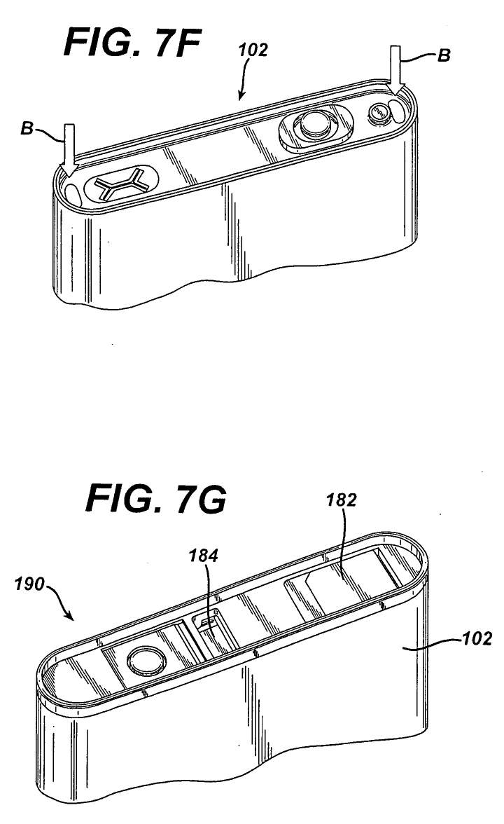

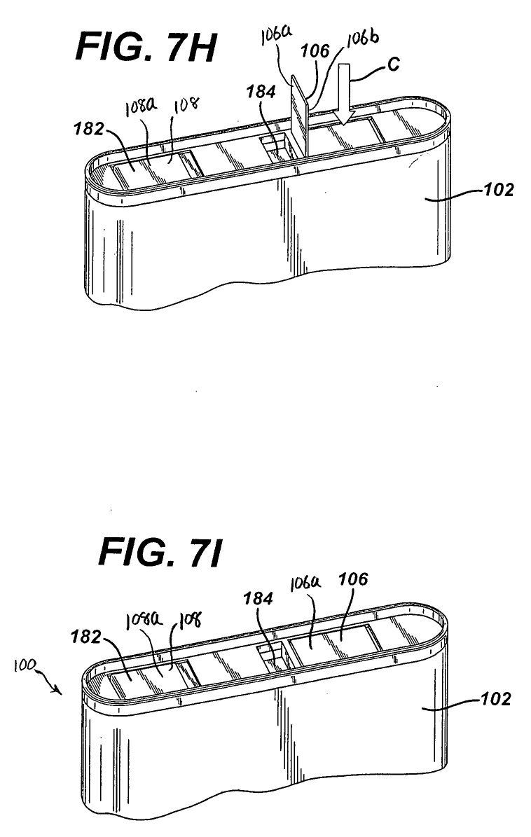

It has been determined that a solution to the problem is simply to plate the exposed surface of the nickel contact 108 and 106 with a layer of gold 108a and 106b respectively. Gold has the advantage over nickel in that it does not develop any significant layer of oxides on its surface, which can significantly increase contact resistance. Gold also has a much lower resistivity than pure nickel. For example, the resistivity of gold is about 2.19 micro-ohm centimeters and the resistivity of pure nickel is about 6.84 micro-ohm centimeters. A preferred embodiment employing gold plated negative and positive terminals for the battery 100 of the invention is shown, for example, in FIGS. 6, 7C, 7H, 7I, and 7J. As shown in the figures, battery 100 housing has two opposing flat sides, typically parallel, running along the length of said housing. With reference to these figures it will be observed that the battery of the invention may have negative contact terminal 108 formed preferably of a nickel substrate 108b which is overplated on its exposed surface with a layer of gold 108a. Similarly, the battery of the invention has its positive contact terminal 106 formed preferably of a nickel substrate 106b, which is overplated on its exposed surface with a layer of gold 106a. The nickel substrate 108b forming the negative terminal may typically have a thickness between about 1 and 10 mil (0.0254 mm and 0.254 mm), preferably between about 4 and 5 mil (0.102 and 0.127 mm). The nickel substrate 106b forming the positive terminal may have a thickness typically between about 1 and 10 mil (0.0254 mm and 0.254 mm), preferably about 5 mil (0.127 mm). The substrates 108b and 106b are preferably at least about 99% nickel. When the contact terminals 108 and 106 have a layer of gold 108a and 106a, preferably of between about 0.25 and 5 micron thickness, plated on the nickel substrate 108b and 106b, respectively, there is noted a marked decrease in the electrical contact resistance with typical camera terminals, to an average level of at least between about 20 and 90 percent less, typically at least 50 percent less than the contact resistance of the same terminals 108 and 106 not plated with gold. Such decrease in contact resistance has been determined to apply over a broad range in contact force between about 50 and 400 grams force, typically between about 50 and 300 grams force even when the camera terminals are also plated with gold. When the contacts 108 and 106 have a layer of gold 108a and 106, preferably between about 0.25 and 5 micron thickness, plated on the nickel substrate 108b and 106b, respectively, there is noted a marked decrease in the electrical contact resistance with camera terminals, to a average level of at least between about 20 and 90 percent less, typically at least 50 percent less than the contact resistance of the same terminals 108 and 106 not plated with gold over a range in contact force between about 50 and 150 grams force. Such reduction in contact resistance applies even if the camera terminals are also plated with gold.

Although nickel is the preferred substrate for terminals 108 and 106 it is not intended to limit the invention to such metal substrates. Other substrates 108b and 106b, for example, stainless steel or silver could be used and overplated with gold and at least some reduction in contact resistance expected. However, the preferred substrate 108b and 106b for use in connection with the battery contact terminals of the invention is nickel. It will be appreciated that the term “nickel” as used in connection with substrate 108b and 106b is intended to extend to alloys of nickel or metals wherein nickel comprises at least a substantial proportion of the substrates composition. Thus the term nickel as used in connection with substrates 108b and 106b is not intended to be limited to pure nickel.

The gold layer 108a and 106a can be applied to metal substrates 108b and 106b, typically of nickel, by conventional electroplating methods employing an electrolysis bath of gold potassium cyanide or equivalent as commonly practiced in the art as referenced, for example in Lawrence J. Durney, Electroplating Engineering Handbook Fourth Edition 1984, pages 226 to 241. Gold may also be applied to the surface of metal substrates such as nickel substrates by sputtering which is a form of plasma or vapor deposition. When gold is applied by sputtering the thickness of the gold layer is typically between about 0.03 and 0.3 micron but may also be somewhat greater. Sputtering has the advantage that very small thicknesses of gold may be applied to the metal substrate, however, it has the disadvantage that it is difficult to use effectively in a mass production setting and also becomes difficult to employ if greater thicknesses of gold are desired. It has thus been determined that in the context of the primary lithium battery of the present invention, it is most desirable to apply the gold plate by electrolysis to the metal substrate 108b and 106b to a plating thickness of between about 0.25 and 5 micron or even greater thicknesses. It has been determined that a lower gold plating thicknesses, for example, in the range between about 0.25 and 1 micron can be employed without sacrifice in obtaining the desired reduction in contact resistance between the battery contact terminals 108 and 106 and corresponding device terminals, e.g. digital camera terminals. Thus, such lower gold plating thicknesses in the range between about 0.25 and 1 micron can be employed to reduce the cost of plating. The gold plating of nickel substrates 108b and 106b to form the battery 100 terminal contacts 108 and 106 (FIG. 6) is especially desirable when the battery is to be employed to power an electronic device, such as a digital camera and the like, which has average pulsed or intermittent power demands between about 2 and 6 watt, with peak demands between about 4 and 6 watts.

The gold plate 108a and 106a may be applied preferably to nickel substrate 108b and 106b according to the specification set forth in ASTM Standard B488-01. It is desirable that the gold plate have a sufficiently high surface hardness that it does not readily indent during the course of battery handling and usage. Such indentation detracts from the overall aesthetic appearance of the contact terminals and could also cause less than expected improvement in contact conductivity compared to unplated nickel.

The gold plating method can be adjusted conventionally in accordance with ASTM specification B488, section 4.2.3. Desirably the gold plating on metal substrate 108b and 106b is adjusted to obtain a Knoop micro hardness (also referred to as Knoop micro indentation) as measured under a 25 gram load (HK₂₅) of between about 130 and 200 HK₂₅ while employing a gold plate thickness between about 0.25 and 5 micron. (The Knoop hardness test as alluded to in ASTM B488 is in effect a micro indentation test which was first developed by the National Bureau of Standards in 1939. The test first involves metallurgically polishing the surface whose hardness is to be measured by way of applying micro indentations on the surface. A surface indenter which is a rhombic-based pyramidal diamond that produces an elongated diamond shaped indent is applied to the polished test surface. The Knoop test can be done generally by applying forces to the indenter between about 10 g to 1000 g.) It has been determined that a gold plate 108a and 106a at thicknesses between about 0.25 and 5 micron, preferably between about 0.25 and 1 micron on a nickel substrate 108b and 106b, respectively, will be sufficiently hard that it does not readily indent during normal handling and usage of the battery of the invention if it has a Knoop micro hardness between about 130 and 200 HK₂₅. The following example is illustrative of the reduction in contact resistance achievable when using gold plated nickel contacts in the primary lithium battery of the invention compared to unplated nickel contacts.

### EXAMPLE 1

A comparative test was made to measure the contact resistance between an unplated nickel contact of about 0.005 inch (0.127 mm) thickness pressed against a gold plated nickel contact (digital camera contact). The surface to surface contact area was about 0.25 mm².

The gold plated digital camera contact was representative of the spring loaded contacts typically employed within digital cameras. The unplated nickel contact was representative of contacts normally used in conventional primary lithium batteries. The contact force between the unplated nickel contact and the digital camera contact was varied between about 50 and 400 grams force. The electrical resistance between the unplated nickel contact and the gold plated digital camera contact was measured at a number of contact forces within this range by applying a pulsed current of about 1 milliAmp between the two contacts. The electrical resistance between the unplated nickel contact and gold plated digital camera contact at 50 grams force was about 20 milliohm and the resistance at 400 grams force was about 5 milliohm. The average contact resistance over the range between about 50 and 400 grams force was about 10 milliohm. The average contact resistance between 50 and 200 grams force was about 14 milliohm.

The same test was then preformed except that the nickel contact was electroplated with a layer of gold having a thickness of about 0.25 micron. The contact force applied to the gold plated nickel contact as pressed against the gold plated digital camera contact was varied between about 50 and 400 grams force. The electrical resistance between the gold plated nickel contact pressed against the gold plated digital camera contact was measured at a number of contact forces within this range. The resistance at 50 grams force was about 4 milliohm and the resistance at 400 grams force was about 1 milliohm. The average resistance over the range between about 50 and 400 grams force was about 2.5 milliohm. The average resistance over the range between about 50 and 200 grams force was about 2.8 milliohm.

Thus, the average contact resistance when using the gold plated nickel contact was approximately 75% percent less than the average contact resistance when using the unplated nickel contact, within the range of contact forces between about 50 and 400 grams. The average contact resistance when using the gold plated nickel contact was approximately 80% percent less than the average contact resistance when using the unplated nickel contact, within the range of contact forces between about 50 and 200 grams.

In a preferred embodiment the battery 100 with gold plated contacts 108 and 106 can be applied to power a Hewlett Packard HP R 707 or Samsung SS UCA-3 digital camera which normally uses a lithium ion rechargeable battery. These cameras have been designed to accommodate the prismatic or flat shaped primary battery of the invention, that is, to allow replacement of the lithium ion rechargeable battery with battery 100 of the invention. Although the position of the negative contact 108 on battery 100 is in the same location as the negative contact in the rechargeable battery, the positive contact 106 in battery 100 is located to the right of where the positive contact of the rechargeable battery contact would normally be when the battery is viewed as in FIG. 6. Desirably the positive contact 106 is separated from the negative contact 108 by a space that is at least about 1.5 times the contact space, for example, at least about 2 times the contact space, typically at least about 2.5 times the contact space. Such camera with instructions from the Applicant herein, could be designed with two positive terminals one to match the location of the rechargeable lithium ion rechargeable battery and the other to match the location of positive contact 106 of the battery of the invention. Thus the rechargeable lithium ion battery which is normally used to power such cameras can be replaced with the primary lithium battery of same overall size and shape, but with a displaced positive contact 106. The advantage of the battery design with displaced positive contact 106 is that the battery 100 of the invention will not become electrically connected with the terminals of conventional rechargers which are normally used to charge lithium ion batteries, even though the battery 100 of the invention is the same size and overall shape as the lithium ion battery. This is because the positive contact 106 on the battery 100 of the invention has been displaced and will not make electrical contact with the corresponding positive terminal on the recharger.

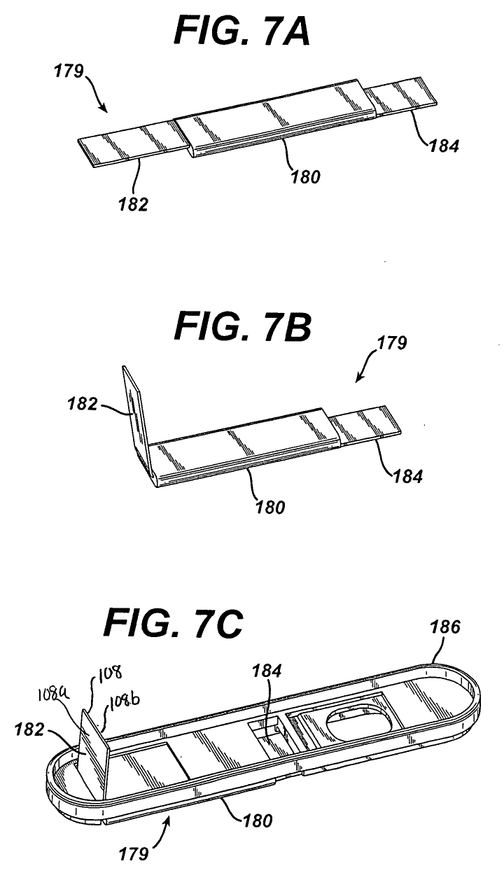

FIG. 5 shows a cell 149 that is contained within battery 100. Cell 149 includes an anode 150, a cathode 154, a separator 158, and an electrolyte 162.

The anode active material in cell 149 can be, for example, lithium or a lithium-containing material (e.g., an alloy that contains lithium and aluminum, calcium, sodium, and/or magnesium).

The cathode active material can be, for example, a metal oxide such as manganese dioxide (MnO₂). In some cases, the cathode active material can be electrolytic manganese dioxide (EMD). Other cathode active materials are described, for example, in co-pending and commonly assigned U.S. Published Patent Application No. US 2003/0124421 A1, published on Jul. 3, 2003 and entitled “Non-Aqueous Electrochemical Cells”, which is herein incorporated by reference in its entirety.

The cathode can include other components, such as a binder (e.g., PTFE) and/or a conductive material (e.g., carbon). Binders are described, for example, in co-pending and commonly assigned U.S. patent application Ser. No. 10/290,832, filed on Nov. 8, 2002 and entitled “Flexible Cathodes”, which is herein incorporated by reference in its entirety.

Separator 158 can be formed of any of the standard separator materials used in nonaqueous electrochemical cells. For example, the separator can be formed of polypropylene (e.g., nonwoven polypropylene or microporous polypropylene), polyethylene, and/or a polysulfone. Separators are further described, for example, in U.S. Pat. No. 5,176,968, which is hereby incorporated by reference in its entirety.

Electrolyte 162 can be in liquid, solid or gel (polymer) form. The electrolyte can contain an organic solvent (e.g., propylene carbonate) or an inorganic solvent (e.g., SO₂, SOCl₂). In some embodiments, the electrolyte can include an additive or additives. For example, the electrolyte can contain a lithium salt such as lithium trifluoromethanesulfonate (LiTFS) or lithium trifluoromethanesulfonimide (LiTFSI), or a combination thereof. Additional lithium salts that can be included are listed in U.S. Pat. No. 5,595,841, which is hereby incorporated by reference in its entirety. Electrolytes are described in previously incorporated U.S. Published Patent Application No. US 2003/0124421 A1.

Referring to FIGS. 6 and 7A, battery 100 preferably includes an assembly 179 with a positive temperature coefficient resistor (PTC) 180 that is connected to leads 182 and 184. Lead 182 serves as negative contact 108, and lead 184, which is welded to battery housing 102, serves as a conductor. PTC 180 can prevent battery 100 from overheating if, for example, a user shorts battery 100. PTC 180 is a thermally sensitive resistor. As the temperature of battery 100 increases, PTC 180 slightly increases the resistance to current flow within battery 100. If a predetermined temperature is reached in battery 100, then PTC 180 substantially increases its resistance to current flow, thereby effectively shutting off the current flow within battery 100 and preventing battery 100 from overheating. After the source of the short has been removed, PTC 180 restores the standard level of resistance within battery 100.

FIGS. 7B-7I show the incorporation of assembly 179 into battery 100 during the manufacture of battery 100. In FIG. 7B, lead 182 is bent to an angle of approximately 90 degrees, and in FIG. 7C, assembly 179 is incorporated into a spacer 186. Referring now to FIG. 7D (in which assembly 179 is rotated approximately 180 degrees relative to its position in FIG. 7C), lead 182 is then folded down in the direction indicated by arrow A. FIG. 7E shows the opposite side of assembly 179 at this point. In FIG. 7F, assembly 179 is then mounted onto housing 102 (e.g., by gluing) in the direction of arrows B, to produce the cell 190 shown in FIG. 7G. Thereafter, and referring now to FIG. 7H (in which cell 190 is rotated approximately 180 degrees relative to its position in FIG. 7G), positive contact 106 is attached (e.g., welded) to cell 190 in the direction of arrow C. Next, as shown in FIG. 7I, positive contact 106 is folded down (and PTC 180 is welded to housing 102). Referring to FIG. 7J, a spacer cover 194 is then placed onto cell 190 in the direction of arrow D.

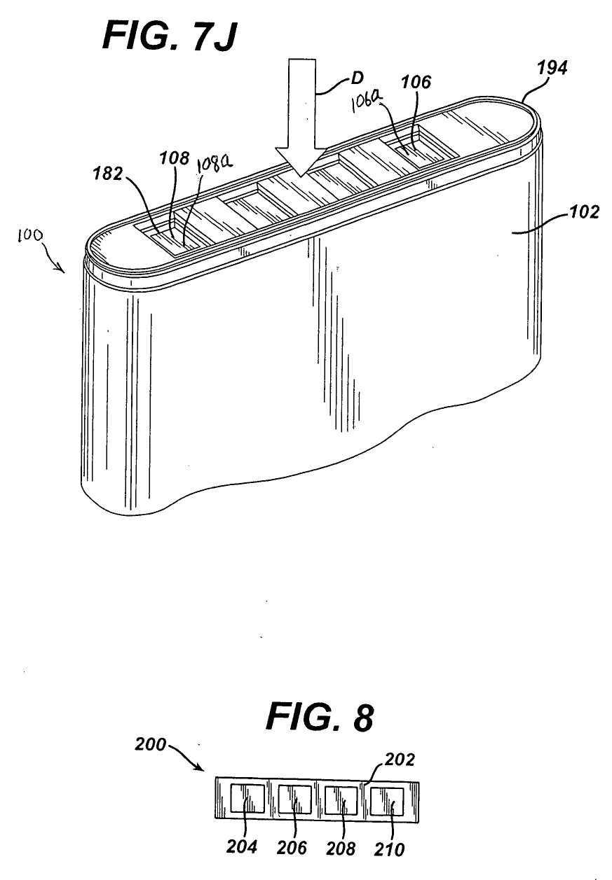

Although one arrangement of contacts on a primary battery is shown in FIGS. 3 and 4, different arrangements are possible. For example, and referring now to FIG. 8, a battery 200 with the same general shape and dimensions as Battery A and battery 100 includes a surface 202 with a negative electrical contact 204 adjacent to a positive electrical contact 206. Surface 202 also includes two recesses, 208 and 210. As with battery 100 of FIGS. 3 and 4, if primary battery 200 were inadvertently placed into a charger for Battery A, battery 200 would not be recharged, since at least one of its electrical contacts would not touch a corresponding contact in the charger.

In some embodiments, and as described above with reference to Batteries D, E, F, and G, the primary battery can correspond to a secondary battery that includes four electrical contacts: a positive contact, a negative contact, a thermistor, and a resistor.

While primary lithium batteries have been described above, other types of battery chemistries can be used. As an example, the primary battery can be an alkaline battery. Alkaline batteries, including suitable anode and cathode materials, are described in, for example, co-pending and commonly assigned U.S. patent application Ser. No. 09/658,042, filed on Sep. 7, 2000 and entitled “Battery Cathode”, and U.S. Published Patent Application No. US 2002/0172867 A1, published on Nov. 21, 2002 and entitled “Battery Cathode”, both of which are herein incorporated by reference in their entirety. Alkaline batteries also are described in U.S. Pat. No. 6,509,117, which is hereby incorporated by reference in its entirety. In some cases, the primary battery is a zinc-air battery. Zinc-air batteries are described in, for example, David Linden, Handbook of Batteries (McGraw-Hill, 2d ed. 1995).

Although the invention has been described with reference to specific embodiments, it should be appreciated that other embodiments are possible without departing from the concept of the invention and are thus within the claims and equivalents thereof.

1. A primary battery comprising a housing having at least one substantially flat side running along the length of said housing, an anode comprising lithium, a negative contact and a positive contact, wherein said negative and positive contacts each comprises a metal substrate overplated with at least one layer of gold on a surface of said substrate facing the external environment.

2. The battery of claim 1 wherein said battery has a pair of opposing substantially flat sides running along the length of said housing.

3. The battery of claim 1 wherein each of said metal substrates comprises nickel.

4. The battery of claim 1 wherein said metal substrate has a thickness between about 1 and 10 mil (0.0254 and 0.254 mm).

5. The battery of claim 1 wherein said gold is plated onto a surface of said metal substrate so that each of said negative and positive contacts has a surface of gold exposed to the external environment.

6. The battery of claim 5 wherein said gold on the surface of said metal substrate has a thickness of between about 0.1 and 5 micron.

7. The battery of claim 5 wherein said gold on the surface of said metal substrate has a thickness of between about 0.25 and 5 micron.

8. The battery of claim 6 wherein said gold forming the surface of each of said negative and positive contacts has a Koop hardness of between about 130 and 200 HK₂₅.

9. The battery of claim 7 wherein said gold forming the surface of each of said negative and positive contacts has a Koop hardness of between about 130 and 200 HK₂₅.

10. The battery of claim 1 further comprising a cathode comprising manganese dioxide.

11. The battery of claim 10 wherein said anode and cathode are each in the form of sheets spirally wound with separator material therebetween.

12. The battery of claim 1 wherein said housing has a thickness of between about 2 mm and 15 mm, a width between about 10 mm and 50 mm, and a length between about 20 mm and 60 mm.

13. The battery of claim 12 wherein said battery does not comprise a thermistor that has an independent contact on said battery housing.

14. The battery of claim 1 wherein the negative and positive contacts are separated by a space that is at least about equal in size to the contact space.

15. The battery of claim 1 wherein the negative and positive contacts are separated by a space that is at least about 1.5 times the size of the contact space.

16. The battery of claim 1 wherein the negative and positive contacts are separated by a space that is at least about two times the size of the contact space.

17. The battery of claim 1 wherein the negative and positive contacts are separated by a space that is at least about 2.5 times the size of the contact space.

18. A primary battery comprising a housing having at least one substantially flat side running along the length of said housing, said housing having a thickness between about 2 mm and 15 mm, a width between about 10 mm and about 50 mm, and a length between about 20 mm and 60 mm, an anode comprising lithium, a negative electrical contact and a positive electrical contact, wherein said negative and positive contacts each comprise a metal substrate overplated with at least one layer of gold on a surface of said substrate facing the external environment.

19. The battery of claim 18 wherein said battery has a pair of opposing substantially flat sides running along the length of said housing.

20. The battery of claim 18 wherein each of said metal substrates comprises nickel.

21. The battery of claim 18 wherein said metal substrate has a thickness between about 1 and 10 mil (0.0254 and 0.254 mm).

22. The battery of claim 18 wherein said gold is plated onto a surface of said metal substrate so that each of said negative and positive contacts has a surface of gold exposed to the external environment.

23. The battery of claim 22 wherein said gold on the surface of said metal substrate has a thickness of between about 0.1 and 5 micron.

24. The battery of claim 22 wherein said gold on the surface of said metal substrate has a thickness of between about 0.25 and 5 micron.

25. The battery of claim 23 wherein said gold forming the surface of each of said negative and positive contacts has a Koop hardness of between about 130 and 200 HK₂₅.

26. The battery of claim 24 wherein said gold forming the surface of each of said negative and positive contacts has a Koop hardness of between about 130 and 200 HK₂₅.

27. The battery of claim 18 wherein the negative and positive contacts are separated by a space that is at least about 1.5 times the size of the contact space.

28. The battery of claim 18 wherein the negative and positive contacts are separated by a space that is at least about two times the size of the contact space.

29. The battery of claim 18 wherein the negative and positive contacts are separated by a space that is at least about 2.5 times the size of the contact space.

30. The battery of claim 18 further comprising a cathode comprising manganese dioxide.

31. The battery of claim 30 wherein said anode and cathode are each in the form of sheets spirally wound with separator material therebetween.
